(19) United States
(12) Patent Application Publication
(10) Pub. No.: US 2005/0034786 A1
(43) Pub. Date: Feb. 17, 2005

(54) Radial sawing method

(76) Inventor: Samuel G. Dargan, Florence, SC (US)

Correspondence Address: Sara A. Centioni;Nexsen Pruet, LLC, PO Drawer 2426, Columbia, SC, 29202-2426, US

(21) Appl. No.: 10/917,632

(22) Filed: Aug. 12, 2004

Related U.S. Application Data
(60) Provisional application No. 60/494,604, filed on Aug. 12, 2003.

(51) Int. Cl. B27L 7/00; B27M 1/08; B27C 9/00; B27B 1/00

(52) U.S. Cl. 144/367; 144/376; 144/379

(57) ABSTRACT

A radial sawing method for cutting a log into six sections. Each resulting section has a triangular wedge shape, such that in cross-section, an angle of approximately sixty-degrees (60°) at the interior edge of the log section is formed. The approximately 60° angle can be the point of an equilateral triangle. After the log has been formed into six pieces that are relatively equivalent in size and shape, each respective piece can then be fed into additional sawing machines for additional processing, such as to form symmetrically shaped pieces, include a circle, a square, a hexagon, an octagon, or other polygon pieces.

### CROSS REFERENCE TO RELATED APPLICATIONS

The present application claims the benefit of priority of U.S. Application No. 60/494,604, filed Aug. 12, 2003.

### STATEMENT REGARDING FEDERALLY SPONSORED RESEARCH OR DEVELOPMENT

Not applicable.

### REFERENCE TO A SEQUENCE LISTING, A TABLE, OR A COMPUTER PROGRAM LISTING COMPACT DISK APPENDIX

Not Applicable.

### BACKGROUND OF THE INVENTION

This invention relates generally to radial sawing methods, and, in particular to a sixty degree radial sawing method.

Various methods are known for sawing raw logs. A vast majority of sawing is done with the initial cut of the log having the saw blade aligned in a tangential orientation to the circle of the log cross-section. This method is referred to as “tangential sawing.”

By contrast, in radial sawing, an initial cut is made through the center to divide the log into two parts, longitudinally. This operation is often performed by a machine called a splitter saw. The splitting cut is aligned with the radius of the circle of the log cross-section.

Radial and tangential sawing methods are also combined when the half-logs resulting from the radial sawing method are made into boards with cuts made at right angles to the flat side of the half-logs.

Radial sawing can be used to produce quarter logs by having a splitter saw cut a log into two halves followed by another splitter saw that cuts the two halves into quarters. This type of sawing can also be referred to a true radial sawing.

Methods also exist to cut shapes into the logs. For example, to produce rounds a round sawing machine can be used. This round sawing machine employs a tubular saw to saw out rounds from a log. Methods also exist to cut square shapes into the logs. Another method includes the manual splitting of ash bolts for making turning stock of baseball bats.

Although these methods are useful for cutting logs, conventional sawing methods are limited, as only certain portions of the log contains high quality wood and other portions contain wood with defects. Therefore, the resulting boards and pieces typically include defects in the wood, because the cuts are made into both the higher quality wood and the lower quality wood of a log. The logs use for various wood cutting applications tend to have the higher quality wood near the outside perimeter of the logs. Accordingly, if cuts are made into the center of the log, the lower quality wood may be incorporated into the resulting board or piece.

Therefore, a need exists for an improved sawing method that will overcome the disadvantages of the prior sawing methods.

### SUMMARY OF THE INVENTION

According to its major aspects and briefly recited, the present invention is a radial sawing method for cutting a log into six sections. Each resulting section has a triangular wedge shape, such that in cross-section, an angle of approximately sixty-degrees (60°) at the interior edge of the log section is formed. The approximately 60° angle can be the point of an equilateral triangle. After the log has been formed into six pieces that are relatively equivalent in size and shape, each respective piece can then be fed into additional sawing machines for additional processing, such as to form symmetrically shaped pieces, include a circle, a square, a hexagon, an octagon, or other polygon pieces.

The present invention can also include an apparatus for use in cutting a log into six sections, wherein each section has approximately a 60° angle at the interior edge along log center. The log-cutting apparatus can include three circular saws, or, alternatively three band saws. The first of these saws is a splitter saw that cuts the log into two halves. The remaining two saws form a double saw having each saw set in a series at approximately 60° angles from the horizontal plane of the cutting board. As each log half passes through the double saw, three pieces are formed including an interior edge having an angle of approximately 60°. These interior edges are joined at the center point of the diameter of the log piece.

This apparatus can also include a continuous feed conveyor system. Centering of the log and the log halves can be done through the use of existing devices for centering the logs along the conveyor depending on what step of the sawing method is being performed. For example, guides on the out-feed side of the saws could hold the log halves together until the saws have completely cut the logs in half and the log halves have cleared the saws.

After the log halves have been formed, the conveyor system can send the logs through the double saw so that pieces can be formed into triangular-shaped wedges having interior edges with angles of approximately 60°. These pieces are next placed onto a conveyor for sorting. Preferably, the pieces are placed onto a conveyor having grooves dimensioned to receive the pieces at the interior point of the pieces. Ultimately, the sawn and sorted pieces are sent into shaping devices to form particularly shaped products or particular size. The sorting can be performed by existing computer scanning technology.

A feature of the present invention is the formation of a log piece that has an angle of approximately 60° at the interior edge of the log piece. As discussed, the pieces are formed into triangular-shaped wedges. Therefore, the cross-section of these pieces includes a triangle. Preferably, the interior edge of the log piece can be the point of an equilateral triangle having angles of 600. Accordingly, for every unit of measurement, such as one inch, that one progresses outward from the interior point (at the center of the log) toward the periphery, the section gets wider by that unit of measurement (measured across to a point on the other flat side an equal distance from the corner), which can serve as the point of an equilateral triangle. The equilateral property of the log section contributes to a highly efficient log configuration, especially if the final product is also symmetrical in cross-section. Such symmetrically sawn pieces are used for “turning stock.” As used herein, “turning stock” refers to sawn pieces of logs that are put into a wood lathe or shaper to produce shaped articles of manufacture such as chair legs, baseball bats, and similarly symmetrically shaped pieces. Furthermore, because of the configuration of the log, more of a given size of a product would be obtained from the higher quality wood near the outside of the log. Generally, this result can be attributed to the fact that the curvature of the circumference of a log is not compatible with the straightness of a saw line. Typically, the wood near the center of the log is of low quality, and suitable only for uses not requiring high-quality wood. Therefore, by cutting the log radially into triangular-shaped sections having an interior edge with an angle of approximately 60°, the lower quality wood remains near the edge of the resulting piece and more of the higher quality wood remains near the center where the final product will be cut. Accordingly, the present log configuration makes more efficient use of the log.

Another feature of the present invention is the use of a method of radial sawing of a log round in six triangular-shaped pieces that are approximately equivalent in size and shape. This method generally yields log pieces that can be most efficiently employed in further processing, such as forming furniture or sports equipment. Typically, some loss of yield efficiency can result from the fact that not every size of a type of piece is readily salable. For example, square-shaped log pieces are typically sold in 2″, 2.5″, and 3″ sizes. The yield loss from market limitations would be mitigated, however, through the selection of various shapes. For example, a log section that would not give a good yield if shaped into a salable hexagon might be efficient for shaping into a salable square. Also, new shapes and sizes might be introduced to the market. The present method introduces great flexibility in log shaping and end products. The radially sawn sections of the present invention can be shaped into any number of geometric shapes, such as hexagons, octagons, rounds, and squares. Another advantage of the present method is flexibility as to the length of log sawn. Other methods, such as those employing tubular saws, can include a positive chucking system, which imposes a maximum and minimum length due to considerations relating to supporting the tube when the log is shorter or longer than the tube. As used here, chucking refers to drilling a hole into the center of a log. Finally, the present method enhances both physical and economic yield of the wood being processed. In conventional sawing, squares are sawn into a log. In such a case, a small log often cannot be sawn to produce a high physical yield, because the heart wood must be avoided, which puts a sever limitation on the sawing of symmetrical pieces. With the radial sawing method of the present invention, however, up to six usable 2″ pieces from logs 7″ in diameter can be produced. Additionally, the advantage in economic yield is even better than that of physical yield. For example, in a standard 10″ diameter log, the central ⅓ of the diameter of the log would be unusable heartwood. Through the use of the present method, the theoretical yield would be nearly 200% of the volume of salable wood from conventional sawing. Because the salable pieces from the present method would be larger, the method would yield 275% of the value derived from conventional sawing. Typically, squares and rounds of larger size sell for higher prices per unit volume (board foot).

Yet another feature of the present invention is the use of a method for radial sawing including the step of forming a variety of shapes simultaneously from the triangular-shaped pieces having an interior point with an angle of approximately 60°. This feature enables both flexibility and efficiency in forming end products. The method of the present invention produces pieces that can be shaped into any number of useful articles such as hexagons, octagons, rounds, or squares. Other methods can typically only produce one type of shape in a single run. However, the present invention has the capability of producing the different shapes in a single run of the sawing machine, as the 60° pieces can be sorted and sent through different shaping machines at one time.

Another feature of the present invention is the use of band saws. This feature saves on the overall energy and cost spent producing the final wood products, because band saws use much less energy than other types of saws, such as tube saws. Also, the equipment could be of lighter construction, because it would be subject to less stress. Finally, the use of band saws would minimize the production of sawdust, because the band saws have a much narrower kerf than other types of saws, such as tube saws. As used herein, the term kerf refers to the pathway of a saw through wood. The kerf is reduced to sawdust. In energy use, the radial sawing method could use band saws, which use much less energy than the tube saw. Also, the equipment could be of lighter construction, because it would be subject to much less stress. Thus, the radial method would save on both energy and capital costs, as compared to tube sawing. Further, because the standards for wood chips have gone up thereby greatly reducing the price of sawdust, the band saws of the present method would minimize the production of this low-value byproduct.

Yet another feature of the present invention is the use of a V-groove conveyor system for sorting the resulting triangular shaped pieces of the present sawing method before they are fed into the shaping machines. Having the pieces in a uniform position facilitates the selection scanning.

Other features and advantages of the present invention will be apparent to those skilled in the art from a careful reading of the Detailed Description of the Preferred Embodiment presented below and accompanied by the drawings.

### BRIEF DESCRIPTION OF THE DRAWINGS

In the drawings,

FIG. 1 illustrates a cross-sectional view of a plurality of stacked rounds according to a preferred embodiment of the present invention;

FIG. 2 illustrates a top view of a honeycomb pattern according to a preferred embodiment of the present invention;

FIG. 3 illustrates a cross-sectional view of a log having a cut pattern according to a preferred embodiment of the present invention;

FIG. 4 illustrates a cross-sectional view of a log having radial cuts along the longitudinal central axis of the log according to a preferred embodiment of the present invention;

FIG. 5A illustrates a cross-sectional view of a log piece according to a preferred embodiment of the present invention;

FIG. 5B illustrates a perspective view of a log piece according to a preferred embodiment of the present invention;

FIG. 6 illustrates a right triangle according to a preferred embodiment of the present invention;

FIG. 7 illustrates a cross-sectional view of log pieces including flitches according to a preferred embodiment of the present invention;

FIG. 8 illustrates a cross-sectional view of a log pieces having cuts along the longitudinal central axes of the log pieces according to a preferred embodiment of the present invention;

FIG. 9 illustrates a cross-sectional view of log pieces having cuts along the longitudinal central axes of the log pieces according to a preferred embodiment of the present invention;

FIG. 10A illustrates a perspective view of an end product made from a log piece according to a preferred embodiment of the present invention;

FIG. 10B illustrates a perspective view of an end product made from a log piece according to a preferred embodiment of the present invention;

FIG. 11 illustrates a schematic view of a method for forming wedge-shaped log pieces according to a preferred embodiment of the present invention;

FIG. 12 illustrates a detailed cross-sectional view taken at Line 12-12 of FIG. 11 according to a preferred embodiment of the present invention;

FIG. 13 illustrates a cross-sectional view of a log piece having a formed cut according to a preferred embodiment of the present invention;

FIG. 14 illustrates a cross-sectional view of a log piece including plural flitches according to a preferred embodiment of the present invention;

FIG. 15 illustrations a cross-sectional view of quarter-sawn board according to a preferred embodiment of the present invention.

### DETAILED DESCRIPTION OF THE PREFFED EMBODIMENT

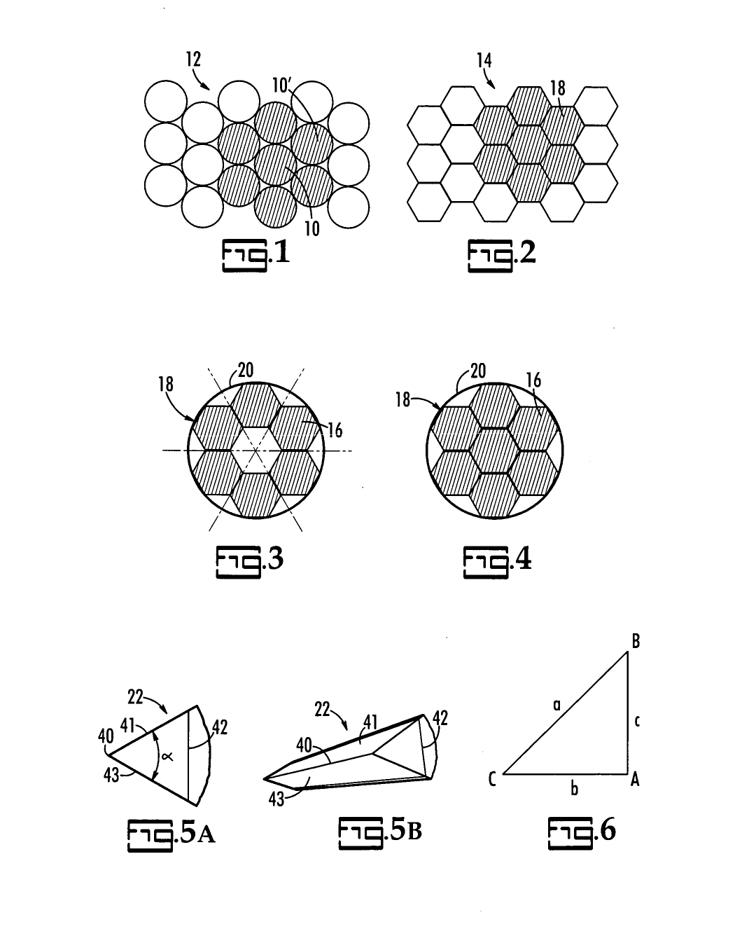

Without limiting the present invention to any particular theory, the initial idea for the present invention came from observing the ends of a plurality of rounds 12, which are large dowel shaped log pieces, that were dead-stacked, meaning there were no spacers between them, as illustrated in FIG. 1. Within the overall pattern was a 7-round pattern 10 (shown by shading), with a round 10′ surrounded by six other rounds 10″.

This 7-round pattern 10 is also the pattern that can be produced by a round saw when sawing a log of sufficient size. As used herein, round saw refers to a saw for forming rounds or tubes out of a log. That is, in order to achieve a high yield of quality rounds in a single log, the round saw can make six cuts around the center of the log, which is usually chucked to remove lower quality wood.

The 7-round pattern 10 formed by the stacked rounds is similar to a honeycomb. An example of a honeycomb pattern 14 is shown in FIG. 2. The honeycomb pattern 14 is known for its efficiency. Scholars as far back as the ancient Greeks have marveled at the efficiency of the honeycomb's high ratio of storage to the wax required to build the walls. The supposition that this structure is the most efficient for storage of liquid has come to be called The Honeycomb Conjecture. Like many important natural phenomena, such as gravity, this has been difficult to demonstrate conceptually. However in 1999; “mathematician Thomas C. Hales of the University of Michigan . . . formulated proof of the so-called honeycomb conjecture, which holds that a hexagonal grid structure represents the best way to divide a surface into regions of equal area with the least total perimeter.” See “The Honeycomb Conjecture, Proving mathematically that honeybee constructors are on the right track,” by Ivars Peterson (www.sciencenews.org/sn_are99/7_{—}24_{—}99/bob2.htm).

If a log could be sawn into the honeycomb pattern 14, the “least total perimeter” of that pattern would be advantageous in two ways. First, the minimization of perimeter means that the total length of saw lines would be minimized, and saw lines are generally associated with cost of production. Secondly, and more importantly, the minimization of perimeter, where the total surface is divided into equal shapes, means that the area of each of these shapes is maximized. Larger cross-sections of product mean significantly higher value, because in dimension products such as rounds and squares, larger cross-sections are generally higher in value per unit volume. Thus, the larger pieces gain in value more than their larger size alone would suggest.

The advantage of sawing a log in the honeycomb pattern 14 can be seen in the roughly round shape of the 7-hexagonal sub-pattern 18 of the honeycomb structure. As illustrated in FIG. 3, 7 hexagonal-shaped pieces 16 can form a 7-hexagonal sub-pattern 18 that can fit neatly within the round cross-section of a log 20. Moreover, the generally lower quality center of the log 20 would affect only one out of the 7 hexagonal-shaped pieces 16 of log 20. The remaining six pieces would be cut from the higher-quality outer portion of a log 20. The concept of applying the honeycomb pattern 14 to cutting a log is novel to the present invention.

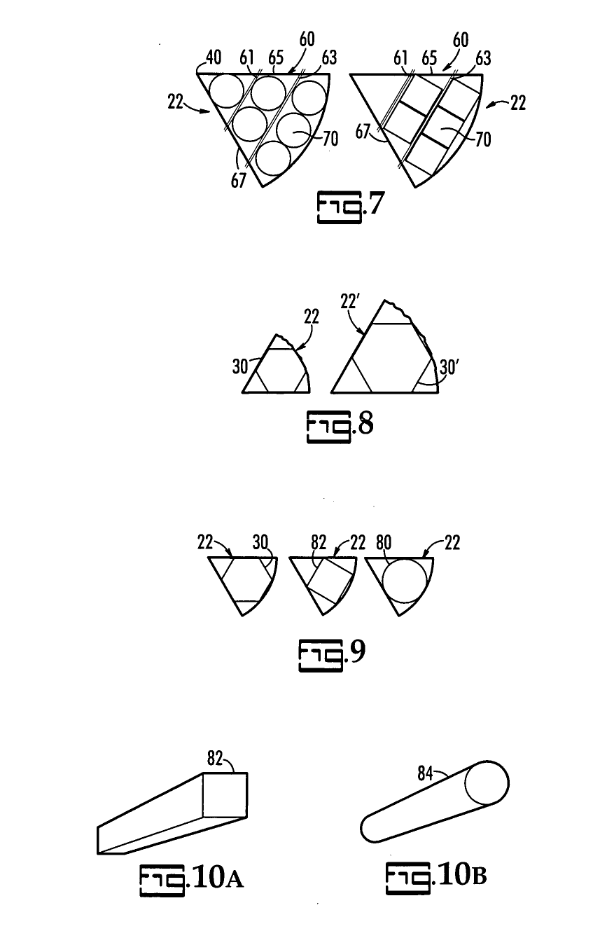

Despite the advantages, employing the honeycomb pattern 14 into the cutting of a log has up until the present been impossible with the conventional sawing methods previously described. However, this honeycomb pattern 14 can be achieved by the radial sawing method of the present invention. By cutting the log 20, which is roughly cylindrical in shape, through the longitudinal axis of the log 20 into six pieces 22 that are approximately equivalent in size and shape, the 7-hexagonal sub-pattern 18 and thereafter be captured as product. The result of this method is illustrated in FIG. 4. As shown, the radial sawing method forms six pieces 22, from each of which an end product can be extracted by the use of saws or other shapers. The six pieces 22 are approximateally equiangular and have cuts that extend radially from the center of the log 20. Each of the six pieces 22 resembles a triangular-shaped wedge and includes an interior edge 40, as shown in FIGS. 5A-5B, formed by a first side 41 and a second side 43. Preferably, the angle between first side 41 and second side 43 is approximately 600 (shown as angle α). As illustrated in FIG. 5A, the cross-section of the wedge piece 22 includes an equilateral triangle 42.

A trigonometric feature of the 60° equilateral triangle 42 enhances the yield of quality wood product. As one moves away from a first point 44 found on the equilateral triangle 42, along a line 46 that bisects angle α, for every inch moved outward, the distance between the first and second sides 41, 43 increases by 1.155 inches. FIG. 6 illustrates one 30° right triangle 50 from the bisected equilateral triangle 42. As shown, the 300 right triangle 50 formed from the equilateral triangle 42 includes sides a, b, and c, and points A, B, and C. The properties of the right triangle 50 are as follows: 1) tangent of point A=0.5774=a/b; 2) a/b=0.5774; 3) a=0.5774b; 4) the distance between point A and point B=2a=0.155b. This trigonometric feature of the wedge sections 22 facilitates a good yield from these sections 22, especially when the end product pieces have a symmetrical cross-section. Each of the triangular-shaped wedge pieces 22 can be sawn into flitches 60, which can then be reduced to pieces of final product, as shown in FIG. 7. As used herein, the term “flitch” refers to an intermediate lumber product having two parallel sides 61, 63 and two nonparallel sides 65, 67. Flitches are edged through the use of edgers to produce boards or other rectangular products. Edgers as used herein refers to sawing machines that square up a board to a desired width. Based on the trigonometric feature of the present invention, if a flitch nearest the interior edge 40 of the wedge section 22 has room for two pieces of end product 70, the adjacent flitch 60 should have room for three pieces, with very little leftover or unused wood.

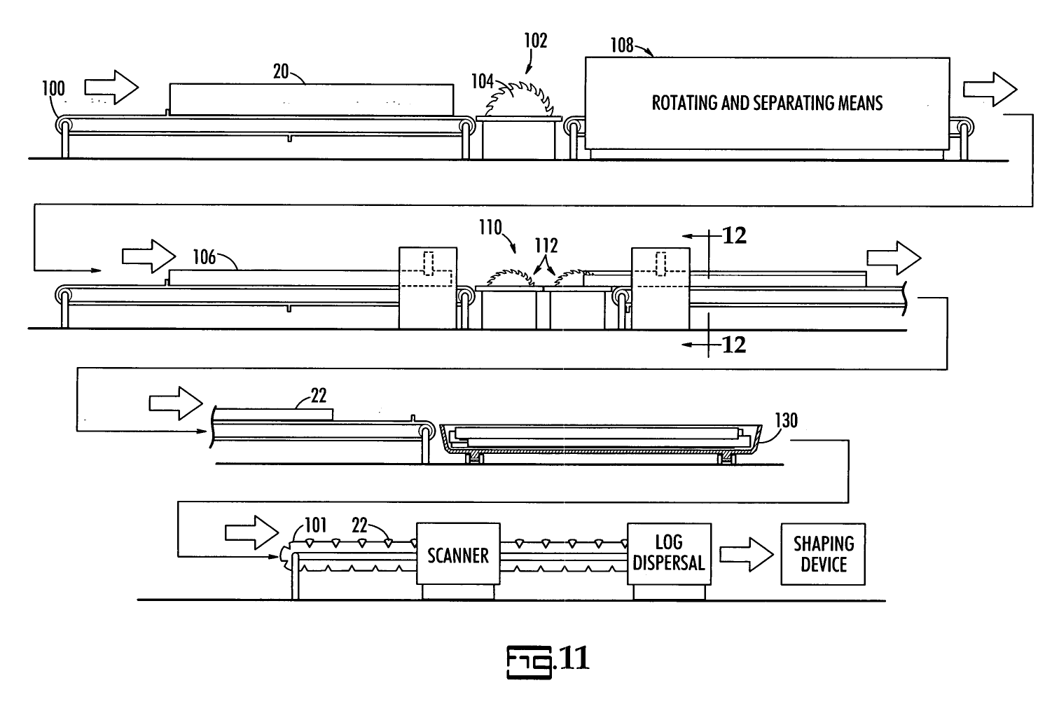

For the present method to be efficient in yield (high ratio of product volume to log volume) the 7-hexagonal pattern should nearly fill the space of the log cross-section. As shown in FIG. 8, the hexagon cut 30 into one of the six triangular-shaped pieces 22. Also shown in FIG. 8, the radial sawing method allows this efficiency to be maintained over a range of log sizes, because the size of the product can be increased as the diameter of the log increases, as shown by hexagon cut 30′ into piece 22′. While a hexagonal-shaped end product is likely the most efficient in yield, rounds and squares can also be produced with higher yields of quality wood over conventional methods. Examples of these shapes are shown in FIG. 9. In addition to the hexagon, a round cut 80 can be made into the log piece 22, as well as a square cut 82. The end products formed from these cuts are shown in FIGS. 10A-10B. As illustrated, the round cut 80 results in a round end product 84, and the square cut 82 results in a square end product 86.

As discussed, a particular feature of the present invention is the use of a method of radial sawing of a log round along its longitudinal central axis into six triangular-shaped pieces that are approximately equivalent in size and shape. This method generally yields log pieces that can be most efficiently employed in further processing, such as forming furniture or sports equipment. Typically, some loss of yield efficiency can result from the fact that not every size of a type of piece is readily salable. For example, square-shaped log pieces are typically sold in 2″, 2.5″, and 3″ sizes. The yield loss from market limitations would be mitigated, however, through the selection of various shapes. For example, a log section that would not give a good yield if shaped into a salable hexagon might be efficient for shaping into a salable square. Also, new shapes and sizes might be introduced to the market. The present method introduces great flexibility in log shaping and end products. The radially sawn sections of the present invention can be shaped into any number of geometric shapes, such as hexagons, octagons, rounds, and squares. Another advantage of the present method is flexibility as to the length of log sawn. Other methods, such as those employing tubular saws, can include a positive chucking system, which imposes a maximum and minimum length due to considerations relating to supporting the tube when the log is shorter or longer than the tube. As used here, chucking refers to drilling a hole into the center of a log. Finally, the present method enhances both physical and economic yield of the wood being processed. In conventional sawing, squares are sawn into a log. In such a case, a small log often cannot be sawn to produce a high physical yield, because the heart wood must be avoided, which puts a sever limitation on the sawing of symmetrical pieces. With the radial sawing method of the present invention, however, up to six usable 2″ pieces from logs 7″ in diameter can be produced. Additionally, the advantage in economic yield is even better than that of physical yield. For example, in a standard 10″ diameter log, the central ⅓ of the diameter of the log would be unusable heartwood. Through the use of the present method, the theoretical yield would be nearly 200% of the volume of salable wood from conventional sawing. Because the salable pieces from the present method would be larger, the method would yield 275% of the value derived from conventional sawing. Typically, squares and rounds of larger size sell for higher prices per unit volume (board foot).

As illustrated in FIG. 11, the present invention also includes an apparatus for use in cutting a log into the six wedge-shaped pieces 22. Although various methods and apparatuses can be employed to produce the six pieces 22 of the present invention, the following is an example of a method and apparatus for forming the pieces. As shown, the log 20 can be placed onto a conveyor system 100. Preferably, the conveyor system 100 is continuous feed. The apparatus of the present invention can also include a means for feeding the log 20 to the conveyor system 100. In a first station 102, the log 20 can be bisected at the diameter of the log 20 by a circular saw or a band saw 104. After passing through the first station, the log 20 is split into two log halves 106, wherein each log half is approximately equal in size to the other log half 106. In a second station 108, the log halves 106 are separated and rotated so that the flat side of each log half 106 comes in contact with the conveyor system 100. Centering of both the log 20 and the log halves 106 can be accomplished by existing devices, such as spring-loaded guide arms or rollers, which are used in existing splitter saws.

As further illustrated, the log halves 106 leaving the second station 108 are transported with the flat side of the log halves 106 face down into a third station 110. In the third station, a double saw 112 including two circular saws, or two band saws, wherein each saw is oriented in a series at approximately 60° angles from the horizontal plane of a cutting board 114. As each log half passes through the double saw 112, three pieces of the six pieces 22 are formed having approximately 60° angles at the between first side 41 and second side 43 of interior edges 40 of the pieces 22. The third station 110 is shown in detail in FIG. 12. Although spring loaded guide arms 120 are illustrated, there exist many alternative means for centering the log halves 106 while they are being cut, and holding the log halves 106 together until they clear the double saw 112. The use of such guide arms 120 would obviate the need for chucking the center section of the log, as that section would be supported by the two side sections, which in turn would be supported by the saw table.

After leaving the third station 110, the wedge pieces 22 can then either be removed from the system into a storing means 130, or the pieces 22 could proceed by the conveyor system 100 to a sorting means 140. A feature of the present invention is the use of a V-groove conveyor belt 101 for sorting the resulting wedge-shaped pieces 22 before they are fed into shaping devices. Having the pieces in a uniform position facilitates the selection scanning. Next, the sorted log pieces 22 could proceed to various shaping devices to form potential end products. Each shaper could produce a particular product, in a particular size. The sorting could employ existing computer scanning technology. Further, the process as a whole could be computer controlled and automated. Alternatively, the process could include manual steps.

The alignment of the sawn pieces 22 for feeding into shapers could employ a number of methods, including the following: 1) guiding along the 60° angle of the sawn piece so that the finished piece would be aligned with the center of the log; or 2) guiding on the outside of the log in each sawn piece so that the finished product would be aligned with the outside of the log. The technique for making the outside-of-log alignment would likely involve making a cut parallel to the outside, and then using this cut as a guide surface for finishing the shaping. This guide would be needed, even for round pieces, if the alignment is with the outside of the log.

As discussed, a feature of the present invention is the step of forming a variety of shapes simultaneously from the resulting wedge-shaped piece 22. This feature makes the invention flexible as to end products. The method of the present invention produces pieces that can be shaped into any number of useful articles such as hexagons, octagons, rounds, or squares. Other methods can typically only produce one type of shape in a single run. However, the present invention has the capability of producing the different shapes in a single run of the sawing machine, as the wedge pieces 22 can be sorted and sent through different shaping machines at one time.

In a first alternative method, the above described system could also be include two secondary saw rigs, each using double band saws, to perform the cutting at the third station 110. This would allow the entire breakdown on the log 20 (into six sections 22) to proceed at about the same rate as the splitting of the log 20 into log halves 106, because the secondary rigs could cut two log halves 106 for every one log 20 the splitter saw processed.

In a second alternative method, the secondary rig referred to above could also be separated into two rigs, each with a single saw. The first secondary rig could saw one wedge piece 22 off the log half 106. Then a second secondary rig (the third step) could saw the remaining part of the log half 106 into two wedge pieces 22. This alternative method may have the advantage of not requiring such expensive in-feed, guide and hold-down systems as previously described methods. When there are two saws engaged in a piece of log at the same time, as in the first alternative method's secondary rig, mentioned above, the piece of log must be fed into the saws in a straight line, with little room for deviations. Small deviations could twist the saw blades. As in the first described method, additional stations could be added for the secondary bread-down of the bolt, so that the secondary break-down could more easily keep up with the primary step, the splitter saw.

In a third alternative method, the six pieces 22 could be produced at a single head-rig, with three band saws placed in close sequence, and set at approximately 60° angles from each other based on a common longitudinal axis. This process could include a centering device to the log vertically as well as horizontally. Also, the log 20 may have to be chucked in six places on the end. These 12 chucks (six on each end of the log) would be supported by a carriage system, which would have sliding components or telescoping features, so that the chucks could reach through the matrix of the three band saws. Such a one-step system would also have to be reciprocating; chucking one log, sawing it, releasing it, and then returning to pick up the next log. An advantage of this process can be that the entire break-down of a log into six wedge-shaped pieces 22 could be accomplished at one head-rig station.

In a fourth alternative method, all the break-down of the log 20 into six wedge-shaped pieces 22 could be done in sequential steps on a single-saw head-rig. First the log 20 could be split into two log halves 106. Then the saw angle would be adjusted, and the accumulated log halves would be fed through to saw off one wedge piece 22 from each log half 106 in relation to the horizontal plane of the cutting board. The saw would then be readjusted, and the log halves having a wedge piece 22 already formed and removed therefrom could be bisected to form two wedge pieces having approximately 60° along the interior edges 40 of the pieces 22. The advantage of this method would be low capital equipment cost.

Another feature of the present invention is the use of multiple saws in combination with a guide system. This apparatus allows various sized logs to be used, making the invention flexible as to the length of log sawn. Other methods, such as those employing tubular saws, have a positive chucking system, which imposes a maximum and minimum length due to considerations relating to supporting the tube when the log is shorter or longer than the tube.

In order to further describe the present invention, the following nonlimiting examples are set forth to show comparative yields of quality wood between the present method and conventional methods. The example is provided for the sole purpose of illustrating the preferred embodiment of the invention and is not to be construed as limiting the scope of the invention in any manner.

A. Logs up to about 14 inches diameter:

For log sizes below about 14 inches and given market limitations on the size of dimension stock, the radial sawing method of the present invention has a clear yield advantage over conventional sawing. In this range, the radial method allows larger size (cross-section) pieces to be economically produced, and since price per unit measure generally increases with size, the radial method has a clear advantage. For example, in a 10 inch log, conventional sawing would allow a theoretical maximum of 11 2-inch squares (2.25″ green), but at least 4 of these would contain substantial quantities of low-quality pith area, so that the marketable yield would be about 7 pieces. The radial method would yield six high quality 2″ squares, or six high quality 3″ rounds (3.25″ green). The 3″ rounds would give a about a 200% advantage in board foot yield from a given log (following the industry practice of counting the round as a square for lumber measurement). As used herein, the term “board foot” refers to a volume measure of lumber that is based on a board that is 1 inch thick, 12 inches wide, and 12 inches long. Therefore, a board foot equals 144 cubic inches of product. In addition, the larger rounds would sell for a higher price per board foot.

For a 14″ log, conventional sawing might get six or seven 3″ squares (or rounds). Radial sawing could get six 3″ squares, or six 4″ rounds. Six 4″ rounds would have 1619=0.178% of the lumber in six 3″ squares. Beyond a 14″ log, however, the economic advantage of radial sawing diminishes, because 4″ is about the largest size of squares or rounds usually produced.

B. Logs above 15 inches diameter:

In making these comparisons, it should be kept in mind that maximum theoretical yield assumes a perfectly cylindrical log, and that the sawing is optimized for yield, neither of which assumptions can be achieved in practice. The theoretical yields only give an indication of the limits of possible yield. How close an actual sawmill comes to those limits will depend on actual equipment, raw materials (logs) and operating procedures. Radial sawing can count on six pieces of some size, but with certain log diameters, the size of the product may not lend itself to a high yield when sawn from certain size logs. I have chosen log sizes and product sizes to give a good yield for the radial method. The average of all log sizes in a range would not be as favorable as these examples.

For a 17″ log, conventional sawing might get 19 pieces of 2.5″ squares, of which at least one would be unusable because of pith. Radial sawing, in the 2-tier mode, might get 18 good quality 2.5″ squares, or 18 pieces of 3″ rounds. (Sawing these large rounds in the 2-tier mode would require special angles for breaking the 60-degree section down into 3 pieces.

For a 27″ log, conventional sawing might get 34 pieces 3″ squares, of which at least 2 would be unusable for pith, leaving possibly 32 pieces saleable. The radial method might get 30 good quality 3″ squares.

C. Special case—square beams/posts in construction lumber:

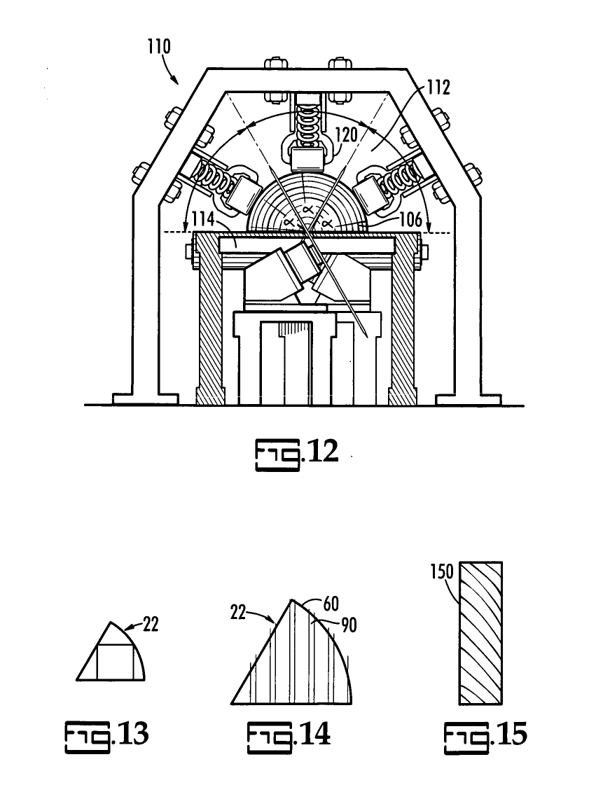

Although hardwood dimension typically does not sell in pieces larger than 4″ diameter, 6×6 posts are commonly made in pine or other construction lumber. In this case, the radial method can be used in the 1-tier mode in larger size logs. For example, from a 24″ log, conventional sawing might produce 6 or 7 pieces of 6×6 posts (6″ green). Radial sawing might also get 6 pieces of good quality, as illustrated in FIG. 13.

In general, the radial method allows better yield in diameters up to about 14 inches, and it allows comparable-to-less yields in larger sized logs. The radial method would usually produce better quality product, because the product would be sawn closer to the outside of the log and farther from low quality wood near the pith.

Although boards are not symmetrically shaped cross-sections, the radial method can be used to advantage in situations where quality of product and speed of production were more important than yield.

Generally, the radial method would have a moderately lower yield than conventional sawing. For example, a 20″ log 16 ft long might yield a maximum of 256 bd. ft. by the radial method, vs. 272 bd. ft. estimated by Scribner scale for conventional sawing. The Scribner scale is a table of estimated lumber yields, calculated by log diameter and length, for conventional sawing. There are three main scales in use: Doyle, which is used often in hardwood dimension; Scribner, which is often used in pine construction lumber; and International. The estimated footages by Scribner scale assume that a conventional headrig will be controlled by a skilled and experienced sawyer. As used herein, a headrig includes a saw or saws that break the log down into intermediate products for further processing. Otherwise, those yields cannot be expected, unless the headrig uses an electronic log scanner and a computer-generated strategy of cuts and turns of the log. There this kind of skill or capital equipment is not available, conventional sawing is unlikely to reach the yields estimated by the Scribner scale.

The radial sawing of a 32″×16 ft. log has a theoretical yield of 707 board feet (for each of 6 sections, two 1×12, three 1×10, two 1×8, two 1×6, one 1×4, and one 1×2). This compares to 741 board feet Scribner scale for conventional sawing. FIG. 14 includes a log section 22 formed by the present method having plural flitches 60. The areas between the flitches 60 indicate saw kerfs 90.

A feature of the present method in sawing boards is that all the boards would be quarter-sawn. As used herein, the term “quarter-sawn” refers to boards or timbers having the wood growth rings running at a diagonal through the cross-section of the piece, as opposed to rings running parallel or at right angles. Because the growth rings of the log would cross diagonally through the cross-section of the boards, the boards are given greater stability and better appearance. The cross-section of a quarter-sawn board 150 is illustrated in FIG. 15.

Overall speed of production can also be enhanced with the present method, because overall speed of a production process is determined by the slowest step. A conventional headrig saws one flitch at a time from a log which is moved back and forth on a carriage. As used herein, the term “headrig” refers to the saw or saws that break the log down into intermediate products for further processing. The radial saw headrig could break the log down into 6 sections in the same time as the conventional headrig produces one flitch. Of course, a (conventional) sash gang saw would produce all flitches in one pass, but almost none of them would be quarter sawn. As used herein, the term “gang saw” refers to a set of parallel saws that reduce a log to flitches in one pass. A gage rip does the same with a flitch or other intermediate product. As used herein, the term “rip” refers to the act of sawing a board or other piece of lumber along its length, parallel to the grain of the wood. A sash gang saw is a headrig that move up and down (instead of circular saws) to reduce a log to flitches in one pass. Thus, to produce quarter sawn boards, a radial sawing system would be faster than a conventional mill. This could be true, even though the radial system requires one more step in the process. The conventional headrig produces flitches, which are then edged to produce boards. This is boards in two steps. The radial mill would produce triangular sections having interior edges with angles of approximately 60° at the headrig. Next, these sections would be gang ripped into flitches, which would then be edged to produce boards. There would be the extra step in the radial method, but all steps would be faster than the headrig of a conventional mill, which was sawing for quality.

Another potential advantage of the present invention can be that maximum yields can be reached without electronic log scanners and a computer-controlled headrig. Thus, the present method might be preferable in Third World countries and other situations where neither sophisticated equipment nor highly skilled sawyers were available.

Those skilled in the art of sawing methods will recognize that many substitutions and modifications can be made in the foregoing preferred embodiments without departing from the spirit and scope of the present invention.

1. A method for cutting a log, comprising:
making a first cut through the diameter of a generally round log;
making a second cut approximately 600 from said first cut through the center of said generally round log; and
making a third cut approximately 60° from said first cut through the center of said generally round log.

2. The method as recited in claim 1, wherein said first cut is made by a first band saw, said second cut is made by a second band saw, and said third cut is made by a third band saw.

3. The method as recited in claim 2, wherein said first band saw, said second band, and said third band saw are spaced apart so that said second cut is made after said first cut, and said third cut is made after said second cut.

4. The method as recited in claim 1, wherein said first cut, said second cut, and said third cut are made simultaneously.

5. The method as recited in claim 1, wherein said second cut and said third cut are made simultaneously.

6. The method as recited in claim 1, further comprising selecting generally round logs substantially shaped like a right cylinder.

7. The method as recited in claim 1, further comprising debarking said generally round log.

8. The method as recited in claim 1, further comprising separating the plural pieces formed from said first cut, said second cut, and said third cut.

9. The method as recited in claim 8, further comprising sorting the plural pieces through the use of a V-groove conveyor belt.

10. The method as recited in claim 9, further comprising shaping the plural pieces into end products.

11. A wedge-shaped log piece formed by a process comprising:
providing a generally round log;
making a first cut through the diameter of said generally round log;
making a second cut approximately 60° from said first cut through the center of said generally round log; and
making a third cut approximately 60° from said first cut through the center of said generally round log.

12. The process as recited in claim 11, wherein said first cut is made by a first band saw, said second cut is made by a second band saw, and said third cut is made by a third band saw.

13. The process as recited in claim 12, wherein said first band saw, said second band, and said third band saw are spaced apart so that said second cut is made after said first cut, and said third cut is made after said second cut.

14. The process as recited in claim 11, wherein said first cut, said second cut, and said third cut are made simultaneously.

15. The process as recited in claim 11, wherein said second cut and said third cut are made simultaneously.

16. The process as recited in claim 11, further comprising selecting generally round logs substantially shaped like a right cylinder.

17. The process as recited in claim 11, further comprising debarking said generally round log.
